(19) United States
(12) Patent Application Publication
(10) Pub. No.: US 2017/0055684 A1
(43) Pub. Date: Mar. 2, 2017

(54) Paint Tray

(71) Applicant: Richard Jackson, Rockledge, FL (US)

(72) Inventor: Richard Jackson, Rockledge, FL (US)

(21) Appl. No.: 15/250,373

(22) Filed: Aug. 29, 2016

Related U.S. Application Data
(60) Provisional application No. 62/210,555, filed on Aug. 27, 2015.

(51) Int. Cl. A45F 3/14; B44D 3/12; B65D 25/40

(52) U.S. Cl. CPC A45F 3/14; B65D 25/40; B44D 3/126; B44D 3/128; A45F 2003/142; A45F 2003/144

(57) ABSTRACT

A paint tray mountable to a person. The paint tray includes a housing having a base, one or more upstanding sidewalls, and an open upper end forming an interior volume that can hold liquid paint. A first sidewall extends past the open upper end and includes an interior side having one or more ridges that distribute paint to a roller as the roller is rolled back and forth across the ridges. A second sidewall, opposing the first sidewall, includes a spout for pouring unused paint from the interior volume. A paint brush holder is positioned over the open upper end and it retains a paint brush when not in use. The first sidewall can be attached to a buckle via a fastener, and the buckle provides for attachment to a person by one or more straps.

### CROSS REFERENCE TO RELATED APPLICATION

This application claims the benefit of U.S. Provisional Application No. 62/210,555 filed on Aug. 27, 2015. The above identified patent application is herein incorporated by reference in its entirety to provide continuity of disclosure.

### BACKGROUND OF THE INVENTION

### Field of the Invention

The present invention relates to paint trays. More specifically, the present invention provides a paint tray for retaining a quantity of paint in a horizontal and vertical orientation.

The application of paint to a wall or other structure conventionally occurs by placing a quantity of paint within a paint container that is moved from location to location as needed. A paint brush or roller is manipulated within the paint container to retain a certain amount of paint thereon, allowing a painter to apply the paint to the wall or other structure. However, painting in this manner presents several difficulties. Moving the paint container creates a risk of spilling the paint on surfaces and increases the risk of falling and injuring oneself when climbing ladders and traversing scaffolding due to having to hold the paint container in at least one hand.

Devices have been disclosed in the known art that relate to paint trays and holsters. However, these devices in the known art have several drawbacks. One problem with conventional paint trays is that a user is required to rest the paint container or tray on a flat surface to prevent an unwanted mess with paint slashing or running down the side of the container. When painting while standing on a ladder or scaffold, there is limited space to stably rest the paint container or tray. Further, the reach of the painter is limited, requiring the painter to continuously move in order to access the entire surface of the wall or other structure to be painted. Thus, the user is required to ascend and descend the ladder while carrying the paint container or tray, putting themselves at risk of serious injury by falling.

A problem also exists when attempting to return any unused paint into the original container when painting is complete. Unused paint must either be poured back into the original container, which leads to a mess or, alternatively, thrown away. Accordingly, there is a need for a paint tray mounted to the waist of a user and maintained in a vertical orientation, wherein the unused paint can be easily emptied therefrom.

In light of the devices disclosed in the known art, it is submitted that the present invention substantially diverges in design elements from the prior art and consequently it is clear that there is a need in the art for an improvement to existing paint tray devices. In this regard the instant invention substantially fulfills these needs.

### SUMMARY OF THE INVENTION

In view of the foregoing disadvantages inherent in the known types of paint trays now present in the known art, the present invention provides a new paint tray wherein the same can be utilized for providing convenience for the user when applying paint to walls and other structures.

It is therefore an object of the present invention to provide a new and improved paint tray. The paint tray comprises a housing including a base, one or more sidewalls, and an open upper end defining an interior volume. The interior volume is configured to store paint when the tray is positioned in a horizontal or vertical orientation.

It is another object of the present invention to provide a paint tray mountable to the waist of a user and maintained in a vertical orientation. A first sidewall includes a fastener that connects to a buckle that may be worn by a user around one's waist. One or more straps extend from the buckle and support to the paint tray in a hands free manner.

Another object of the present invention is to provide a paint tray wherein unused paint can be easily emptied therefrom. A second sidewall includes a spout for pouring the contents of the housing without causing an unwanted mess with paint splashing or running down the side of the original container.

Yet another object of the present invention is to provide a paint tray that maintains paint in the housing when the tray is positioned in both a horizontal and vertical orientation, and provides ridges to distribute paint across a paint roller as the paint roller is rolled back and forth thereacross.

Another object of the present invention is to provide a paint tray that may be readily fabricated from materials that permit relative economy and are commensurate with durability.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of the paint tray.

FIG. 2 shows a perspective view of the paint tray in an inverted orientation.

FIG. 3 shows a perspective view of the paint tray mounted to the waist of a user.

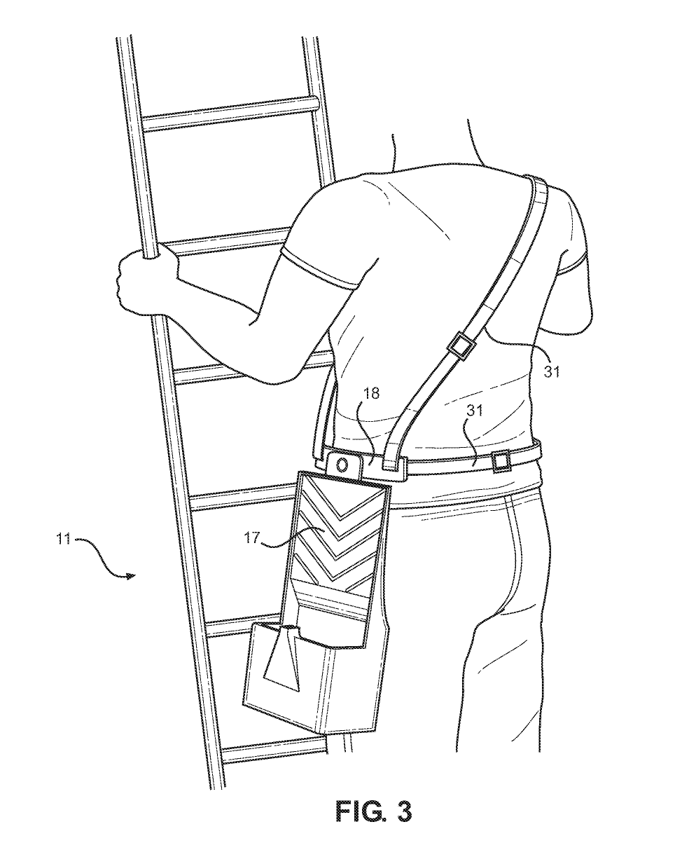

### DETAILED DESCRIPTION OF THE INVENTION

Reference is made herein to the attached drawings. Like reference numerals are used throughout the drawings to depict like or similar elements of the paint tray. For the purposes of presenting a brief and clear description of the present invention, the preferred embodiment will be discussed as used for storing liquid paint. The figures are intended for representative purposes only and should not be considered to be limiting in any respect.

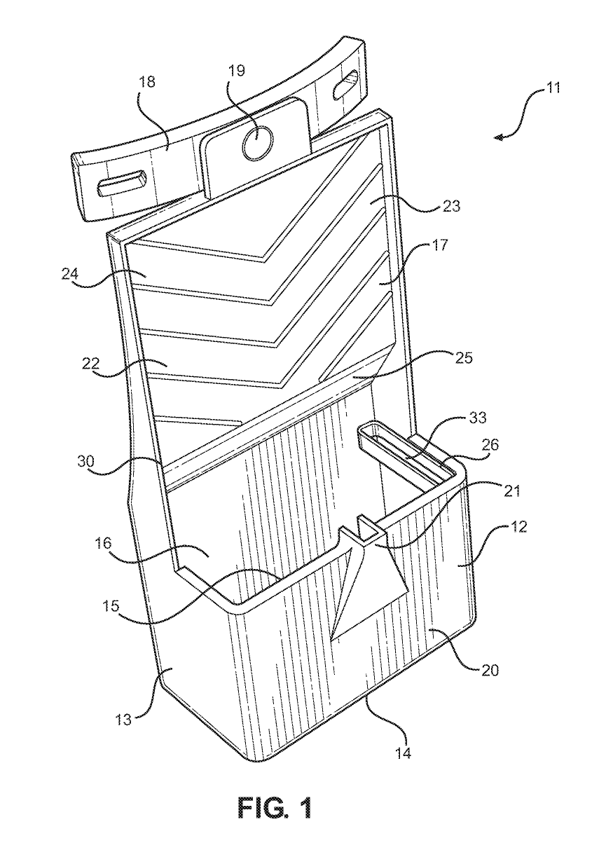

Referring to FIG. 1, there is shown a perspective view of an embodiment of the paint tray. The paint tray 11 provides a paint holder or reservoir that can be positioned to a waist of a user for hands free use. The paint tray 11 comprises a housing 12 having a base 14, one or more sidewalls 13 extending therefrom, and an open upper end 15 defining an interior volume 16. The interior volume 16 is configured to store liquid paint therein. In the shown embodiment, the paint tray 11 is in a vertical orientation, such that the base of the housing is parallel to the floor. The housing 12 comprises a generally rectangular shape, however in alternative embodiments, the housing may include circular, polygonal, or any other shape.

The one or more sidewalls 13 comprises a first sidewall 17 that extends past the open upper end 15 of the housing 12. In one embodiment, the first sidewall 17 comprises an inclined portion 25 and a planar rectangular portion 24, wherein the inclined portion 25 leads away from the housing 12 and joins the planar rectangular portion 24. The first sidewall 17 is configured to rest against a user's body when disposed in a vertical orientation. Further, the first sidewall 17 is configured to affix to a buckle 18 that is removably securable to the first sidewall 17 via a fastener 19. In the shown embodiment, the fastener 19 is a snap-fit connection at the upper end of the first sidewall 17 in order to suspend the paint tray 11 in a vertical orientation. The shown fastener 19 includes a protruding male connector that is pivotally fitted with a female aperture connection of the first sidewall 17. In the shown embodiment, the buckle 18 is curved so as to conform to the shape of a user's waist. The buckle includes one or more apertures configured to receive straps therethrough in order to suspend the paint tray 11 in a vertical orientation.

The one or more sidewalls 13 also comprises a second sidewall 20 opposing the first sidewall 17, wherein the second sidewall 20 includes a spout 21 configured to pour liquid contents from the interior volume 16 of the housing 12. In one embodiment, the contents of the housing 12 which can include liquid paint. In the vertical orientation, a user can position the paint tray 11 adjacent to their waist and apply paint to a paint brush or paint roller as desired.

The first sidewall 17 of the paint tray 11 comprises an interior side 22, wherein the interior side 22 is substantially parallel to the floor and facing thereaway when disposed in a horizontal orientation. In the shown embodiment, the interior side 22 of the first sidewall 17 comprises one or more ridges 23 that protrude away therefrom. The one or more ridges 23 provide a surface that assists with the removal and even distribution of paint across a paint brush or roller. In use, paint is applied to the brush or roller, and the brush or roller is moved back and forth over the one or more ridges 23 so as to distribute the paint thereto. In the shown embodiment, the one or more ridges 23 comprise a chevron pattern that removes and directs excess paint away from a paint roller when rolled thereagainst. However, in alternative embodiments, the one or more ridges 23 may comprise any pattern.

In one embodiment, the first sidewall 17 also includes a raised border 30 configured to retain paint within the housing 12. The raised border 30 is disposed along the perimeter of the interior side 22. In some embodiments, the raised border 30 may protrude between 1 and 3 inches. However, alternative embodiments include any dimensions.

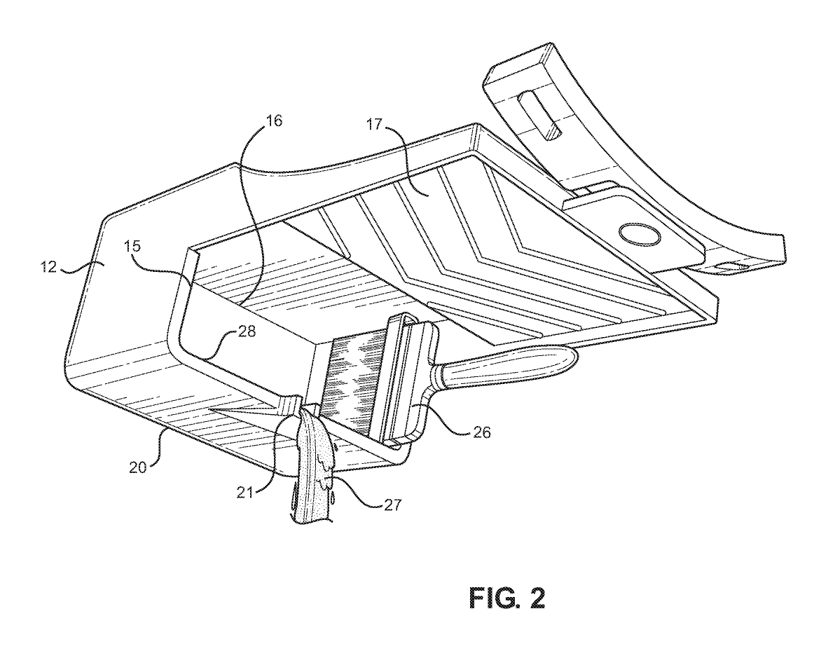

Referring to FIG. 2, there is shown a perspective view of the paint tray wherein paint is emptied therefrom. The paint tray 11 comprises a spout 21 disposed on the second sidewall 20 of the housing 12. In the shown embodiment, the spout 21 comprises an annular channel configured to pour out contents of the housing 12 and is disposed on the second sidewall 20, wherein the spout 21 extends outwards toward the exterior of the tray 11. In use, unused paint 27 or other housing contents, is removed from the housing 12 by inverting the paint tray 11 such that the paint 27 is directed from the spout 21. In an inverted orientation, the first sidewall 17 is parallel to the floor and facing thereto. In an alternative embodiment, the spout 21 is disposed on another of the one or more sidewalls.

The paint tray 11 further includes a paint brush holder 26 configured to retain a paint brush therein. The paint brush holder 16 is disposed over the open upper end 15 of the housing 12. In the shown embodiment, the paint brush holder 26 comprises a U-shaped member that span between the first sidewall 17 and the second sidewall 20 defining a gap 33 therebetween. The gap 33 is configured to receive a portion of a paint brush therein and support the received paint brush until removed by a user.

The upper end 15 of the housing 12 comprises a lip 28 around the perimeter thereof, wherein the lip 28 is configured to retain paint 27, or other contents of the housing 12, within the interior volume 16. The lip 28 extend towards the center of the housing 12 between approximately 0.25 inches and 2 inches. However, in alternative embodiments, the lip 28 dimensions may vary.

Referring to FIG. 4, there is shown a perspective view of the paint tray mounted to the waist of a user. The paint tray 11 is in a vertical orientation and secured to a user at the waist via the buckle 18. One or more straps 31 extend through each aperture of the buckle 18. The straps 31 are configured to be worn over the user's shoulder and around the user's waist to support the paint tray 11. Further, the first sidewall 17 is pivotally affixed to the buckle 18 via a fastener, thereby maintaining the vertical orientation when suspended therefrom. In this way, the paint tray 11 is accessibly positioned adjacent to the user.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A paint tray, comprising
a housing having a base, one or more sidewalls extending therefrom, and an open upper end, defining an interior volume, the interior volume configured to store liquid paint therein;
the one or more sidewalls comprising a first sidewall that extends past the open upper end, the first sidewall configured to affix to a buckle via a fastener,
the one or more sidewalls comprising a second sidewall opposing the first sidewall, the second sidewall including a spout configured to pour out contents of the interior volume of the housing.

2) The paint tray from claim 1, wherein:
the first sidewall comprises an interior side including one or more ridges, the one or more ridges configured to remove paint from a paint brush from contact therebetween.

3) The paint tray from claim 2, wherein:
the one or more ridges comprise a chevron pattern.

4) The paint tray from claim 1, wherein:
the first sidewall comprises an inclined portion and a planar rectangular portion, wherein the inclined portion leads away from the housing and joins the planar rectangular portion.

5) The paint tray from claim 1, further comprising:
a paint brush holder disposed over the open upper end of the housing, the paint brush holder configured to retain a paint brush therein.

6) The paint tray from claim 5, wherein:
the paint brush holder comprises a U-shaped member that span between the first sidewall and the second sidewall defining a gap therebetween, the gap configured to receive a portion of a paint brush therein.

7) The paint tray from claim 1, wherein:
the upper end of the housing comprises a lip around the perimeter thereof, the lip configured to retain liquid paint within the interior volume.

8) The paint tray from claim 1, further comprising:
a buckle configured to configured to affix to the first sidewall via the fastener, wherein the buckle includes one or more apertures each configured to receive a strap therethrough.

9) The paint tray from claim 8, wherein:
one or more straps are connected to the buckle, the one or more straps configured to be worn over a user's shoulder and around the user's waist to support the housing.

10) The paint tray from claim 1, wherein:
the fastener comprises a snap-fit connection, the snap-fit connection comprising a protruding male connector that pivotally fits with a female aperture connection.

11) The paint tray from claim 1, wherein:
the first sidewall comprises a raised border configured to retain paint within the housing, the raised border disposed along the perimeter of the interior side thereof.
